(19) United States
(12) Patent Application Publication
(10) Pub. No.: US 2007/0196053 A1
(43) Pub. Date: Aug. 23, 2007

(54) Isolated Fiber Optic Union Adapters

(75) Inventor: Anthony S. Kewitsch, Santa Monica, CA (US)

Correspondence Address: ANTHONY KEWITSCH, 515 OCEAN AVE., UNIT 505-S, SANTA MONICA, CA, 90402, US

(73) Assignee: Anthony S Kewitsch, Santa Monica, CA (US)

(21) Appl. No.: 11/307,688

(22) Filed: Feb. 17, 2006

(51) Int. Cl. G02B 6/38

(52) U.S. Cl. 385/74; 385/55; 385/58; 385/60; 385/70; 385/72; 385/73; 385/75

(57) ABSTRACT

Devices to enhance the reliability of optical networks and to reduce the cost of repair are disclosed in this invention. In particular, fiber optic union adapters with built-in protective isolation prevent a damaged, connectorized fiber optic cable from degrading other fiber optic terminations within the network should they be physically connected. The fiber optic union comprises a split sleeve with an interior channel and a fiber stub centrally located within the interior channel. The fiber stub prevents the ferrules of two different cables from making direct physical exchange but allows them to make efficient optical exchange. Opposite ends of the fiber stub are optically polished to enable physical contact to the ferrules of fiber optic cables with low insertion loss and low backreflection. Devices to achieve low loss isolated interconnection between cables containing dissimilar fiber types by use of a fiber taper are further disclosed.

### FIELD OF THE INVENTION

This invention relates to optical systems using fiber optic cables to transmit illumination and/or signals, and more particularly to devices and methods to enable the low loss connection of fiber optic cables while preventing the spread of damage from one cable to another.

### BACKGROUND OF THE INVENTION

In the majority of applications, fiber optic cables are terminated with connectors so they can interchangeably interface with other patchcords or fiber optic devices having the same type of connector. These connectors typically utilize an assembly including an optical fiber, one end of which is stripped to expose the bare glass and bonded within a precision, close tolerance hole of a ferrule. The fiber and ferrule endfaces are made co-planar and optically smooth by subsequent polishing of the endface. In the common male-type fiber optic termination, the polished ferrule/optical fiber element extends beyond the boundary of the connector housing.

These male-type connectorized fibers may be interconnected to one another with low optical loss (<0.25 dB) in transmission by attaching the connectors to opposite ends of a fiberoptic union adapter placed therebetween. This union adapter consists of a housing with opposing receptacles surrounding a hollow, precision split sleeve whose nominal inner diameter is slightly less than the outer diameter of the ferrules in the connectors. This union adapter includes no internal optical surfaces or optical elements. It serves merely as an alignment sleeve.

Insertion of connectorized fiberoptic cables into opposite ends of the union adapter forces their ferrule/optical fiber elements to be in precise concentric alignment. The insertion of the ferrules enlarges the inner diameter of the split sleeve slightly, this sleeve thereby produces a slight compressive force on the ferrules which aligns their outer diameters concentrically. Since the optical fiber core is concentric with the optical fiber outer diameter, and the hole within the ferrule is concentric with the ferrule outer diameter at both ends of the ferrule, the two fiber cores are automatically aligned concentrically to within sub-micron tolerances. The polished endfaces of the fiber/ferrule assemblies of the two different cables are mechanically and optically contacted within the split sleeve, due to the slight axial force on the ferrules once the bodies of the connector assemblies are attached to the housing of the union adapter.

Due to the delicate nature of polished glass surfaces, the ferrule contact areas are highly susceptible to scratching caused by contaminants trapped within the contact area. Surface damage has the potential to degrade optical characteristics at the interface in the vicinity of the fiber optic core. Furthermore, a single contaminated or damaged fiber/ferrule, if connected to other clean and undamaged fiber terminations, can degrade these other fiber terminations and propagate connector damage throughout the network. The increased excess loss and reduced return loss can seriously compromise the network's performance. With broadcast-type access networks, in which the optical signal is power split between as many as thirty-two users, the optical power budget of the network is strained and the impact of such damage is particularly significant.

The primary users of fiber optic telecommunications equipment have been service providers delivering data, video and telephone transmission, and their optical networking equipment has been centrally located within specialized facilities maintained by highly experienced engineers. It is anticipated that optical fiber deployments will become increasingly common in local area networks (LANs) within the facilities of the service provider's customers. In this situation, the cost to diagnose and repair damaged terminations may increase considerably depending on the physical location of the termination within the network. For instance, damage to the connectorized drop cable within a customer's wall requires a costly service call and repair by an experienced technician. Alternately, damage at the connector interface of a populated, high-density fiber patch panel requires a costly procedure to gain physical access to the damaged connector. These are two examples of what may be characterized as “critical” fiber optic terminations.

Fiber optic deployment in the local area network is also highly connectivity dependent, adding challenges in maintaining high performance. For instance, fiber cables attach from wall or desk mount interface plates to fiber optic modems or gigabit Ethernet transceivers. Typically, the ends of fiber optic drop cable within the customer's premises are terminated using highly specialized and costly fiber optic termination equipment. Once the fiber build-out is complete, it is important that continued proper handling of the fiber cable and connectors preserve the performance of the network. Fiber optic cable is particularly susceptible to cracking due to excessive bends and polished fiber optic terminations are susceptible to scratching due to dirty and contaminated connectors. Repair and debugging requires highly skilled fiber optic technicians, adding significant cost and overhead to maintain the network.

To mitigate potential disruption and degradation of performance as optical fiber networking equipment spreads to the local area network, fiber optic equipment must be designed to be robust under these new conditions. Present day fiber optic systems lack the robustness commonly found in electronic networking systems. For instance, fiber optic union adapters for the various connector styles (FC, SC, ST, LC, MTRJ) are available from multiple suppliers such as Seikoh Giken USA, Inc. and Adamant Kogyo Inc. These adapters include an internal split sleeve for direct physical contact and alignment of opposing connector ferrules. Recent advances in the design of union adaptors have focused on approaches to prevent contamination from entering the critical split sleeve area. This contamination may cause damage to the ferrule end faces. Prior art approaches to improving the robustness of fiber optic connections have centered on the development of various shields and covers to help prevent contamination from entering the union adaptor body. U.S. Pat. No. 5,887,098 by Ernst et al. discloses an FC-type fiber optic union adapter with a two-part shield assembly to cover the end of the receptacle when a cable is not attached. U.S. Pat. No. 6,863,445 by Ngo describes an alternate cap design for SC type fiber optic union adapters. These approaches do not prevent a damaged connector ferrule from damaging the mating connector.

Fixed fiber optic attenuators similar in geometry to the aforementioned fiber optic union adapters have also been developed. These devices produce attenuation by providing an air gap or misalignment between opposing connector ferrules or by inserting a lossy optical element between the mating ferrules. For example, U.S. Patent Application 2003/031423 by Zimmel describes an SC-type fiber optic adapter which includes a sheet of attenuator glass embedded at the longitudinal center of the alignment split sleeve. This adapter produces significant insertion loss (>=5 dB) since it is designed to produce attenuation. One consequence of this attenuator design is the elimination of direct physical contact between mating connectors; however, it does so while introducing a significant amount of loss. Therefore, there is a great need to develop a low loss, low cost union adapter which prevents the propagation of damage from one connector to another. It is further advantageous to provide the ability to connect two dissimilar fibers in a low loss fashion within the union adapter.

### BRIEF DESCRIPTION OF THE FIGURES

FIG. 1 illustrates an isolated fiber optic union adapter attached to a wall mounted interface plate;

FIG. 2 illustrates a side view an isolated fiber optic union adapter attached to a wall mounted interface plate;

FIG. 3 illustrates a cross sectional view of an SC-UPC type isolated fiber optic union for joining two male connector ends;

FIG. 4 illustrates an exploded view of an SC-UPC type isolated fiber optic union for joining two male connector ends;

FIG. 5 illustrates an alternate embodiment of an isolated adaptor installed behind a standard electrical outlet cover plate;

FIG. 6 illustrates a cross sectional view of an FC-APC type isolated fiber optic union for joining two male connector ends;

FIG. 7 illustrates a front view of an FC-APC type isolated fiber optic union;

FIG. 8 illustrates a cross sectional view of an FC-APC type union attached to a pair of fiber optic cables;

FIG. 9 illustrates a cross sectional view of a fiber optic male-to-female adapter for joining male to female fiber optic connectors;

FIG. 10 illustrates a fiber optic transmission device including integrated isolated adapters;

FIG. 11 illustrates a cross sectional view of a dissimilar fiber stub to transition between connectorized bend insensitive fiber and standard single mode fiber;

FIG. 12 illustrates the process of producing the adiabatic taper by electrical arcing, and

FIG. 13 depicts a flow diagram outlining the steps of producing a fiber stub including an adiabatic taper.

### SUMMARY OF THE INVENTION

This invention discloses isolated fiber optic union adapters that reduce the potential for damage to “critical” fiber optic terminations which are costly to repair. These adapters include a low cost internal fiber stub element within a precision alignment sleeve to prevent direct physical contact between the polished end faces of connectorized fibers while providing highly efficient optical coupling between the same connectorized fibers. The internal fiber stub element includes a length of single mode or multi-mode fiber(s) bonded within a precision ferrule and polished on opposite end faces. The optical fiber type and polished end face characteristics are selected to be nominally identical to the connectorized fibers attached thereto. The end faces are polished and in some cases antireflection coated to provide sufficiently low backreflection and insertion loss from the interfaces. The connectorized fiber are potentially dissimilar, in which case the fiber stub further includes a low loss adiabatic transition. Such a transition may be produced by fiber core diffusion and fusion splicing.

### DETAILED DESCRIPTION OF THE INVENTION

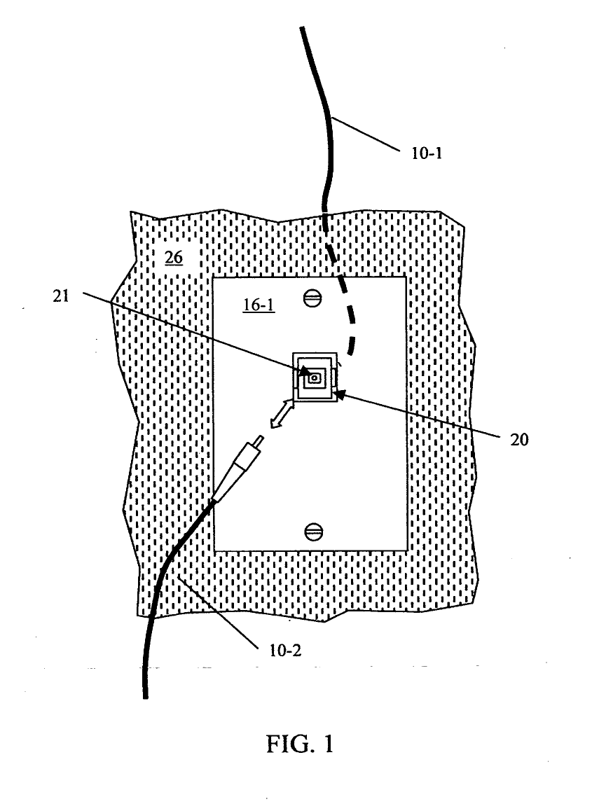

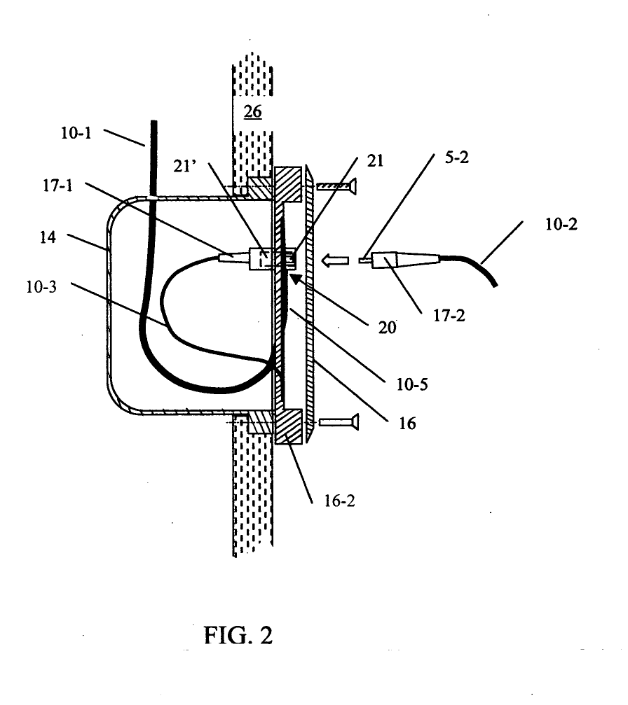

FIG. 1 illustrates a front view of an isolated fiberoptic union adapter 20 mounted to a wall plate 16 attached to wall surface 26. The connectorized end of a fiber optic patchcord 10-2 may be inserted into the front receptacle 21 of union adapter 20 to optically interface this patchcord 10-2 to a critical fiber optic drop cable 10-1 located within the plenum of a wall 26. FIG. 2 illustrates a side cutaway view of this same configuration, wherein the critical terminated end 17-1 of fiber 10-1 is inserted into the back receptacle 21′ of adapter 20. During the initial build-out of the fiber optic network, the jacket at the end of drop cable 10-1 is typically stripped to expose tight buffered optical fiber 10-3 of 900 micron diameter. An excess fiber length 10-5 is spooled after the fiber 10-1 is terminated with a polished connector 17-1, by use of a partial spool mandrel formed in the plastic injection molded interface plate 15. This polished connector 17-1 is produced either by an on-site polishing process or by fusion splicing a polished connector pigtail to the drop fiber 10-1. The polishing process and the fusion splicing process requires considerable skill and costly equipment to perform adequately. Therefore, the protection of connector 17-1 from damage during routine plugging and unplugging of fiber optic connectors into receptacle 21 over the service life of the network is important.

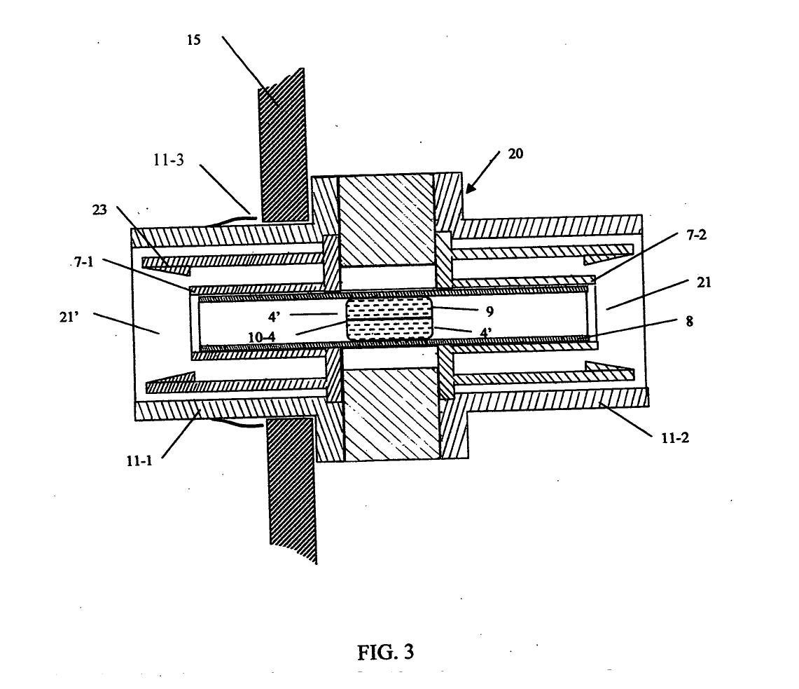

Should a patchcord 10-2 and connector 11-2 with damaged or dirty ferrule tip 5-2 be inserted into the front receptacle 21 of union adapter 20, a replaceable, isolated union adapter 20 (detailed in cross section in FIG. 3) with internal isolation fiber stub 9 would protect the polished ferrule tip of critical termination 11-1. The union adaptor 20 would be damaged, but this device is designed to be sufficiently low cost such that it can be replaced by a simple and economical process. Replacement of isolated union adapter 20 is facilitated by use of a spring clip mechanism 17 to attach to interface plate 15, for example. The restoration of the network simply requires that cable 10-2 and fiber stub 9 of isolated union adapter 20 be replaced in a simple exchange of relatively inexpensive components. This eliminates the need for a costly service call by a repair technician 11-1.

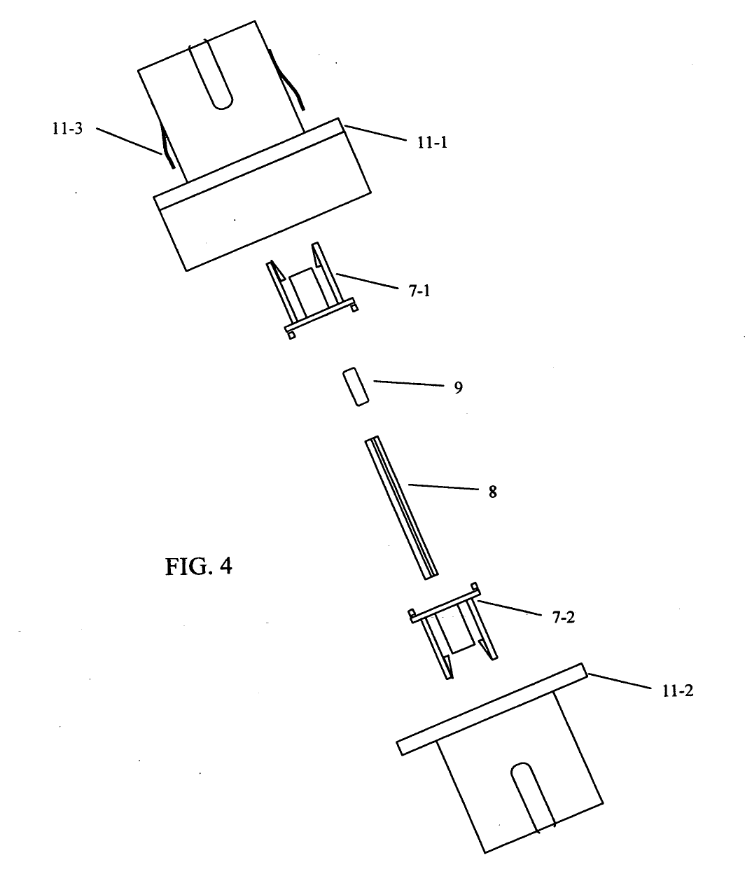

FIG. 3 details in cross section a plug-in type isolated union adapter with fiber stub 9 including a length of single mode (e.g., SMF-28e fiber from Corning Inc.) or multimode (e.g., 50/125 micron Infinicor from Corning Inc.) fiber 10-4 along the longitudinal axis with ultra-physical polish (UPC) endfaces 4′. The endfaces have a slight radius of curvature (dome) to provide physical contact. The optical characteristics such as core diameter of fiber 10-4 are selected to be nominally identical to that of fibers 10-1 and 10-2. The angle and curvature of the polished surfaces 4′ are provided in accordance with the standards developed for PC (physical contact), UPC (ultra-physical contact) or APC (angled physical contact) type connectors. This surfaces 4′ typically have a large radius of curvature (typically 20 mm) to produce a slight “dome” on the end face. On the scale of FIG. 3, this radius is sufficiently large that the dome is not apparent. The end faces typically have a slight circumferential bevel that extends in about 100 to 300 microns radially from the outer diameter of the stub. Within body 11 lies the precision split sleeve 8 held longitudinally and radially by a two part outer sleeve 7-1 and 7-2. The fiber stub 9, including embedded fiber 10-4 is epoxied within split sleeve 8. FIG. 3 depicts a single connector (SC style, simplex type); however, this approach can be extended to duplex or multi-fiber type connectors. The split sleeve is typically fabricated of ceramic or phosphor bronze and the housing 11 is typically fabricated of injection molded plastic. The elements comprising a typical isolated union adaptor are illustrated in exploded view in FIG. 4.

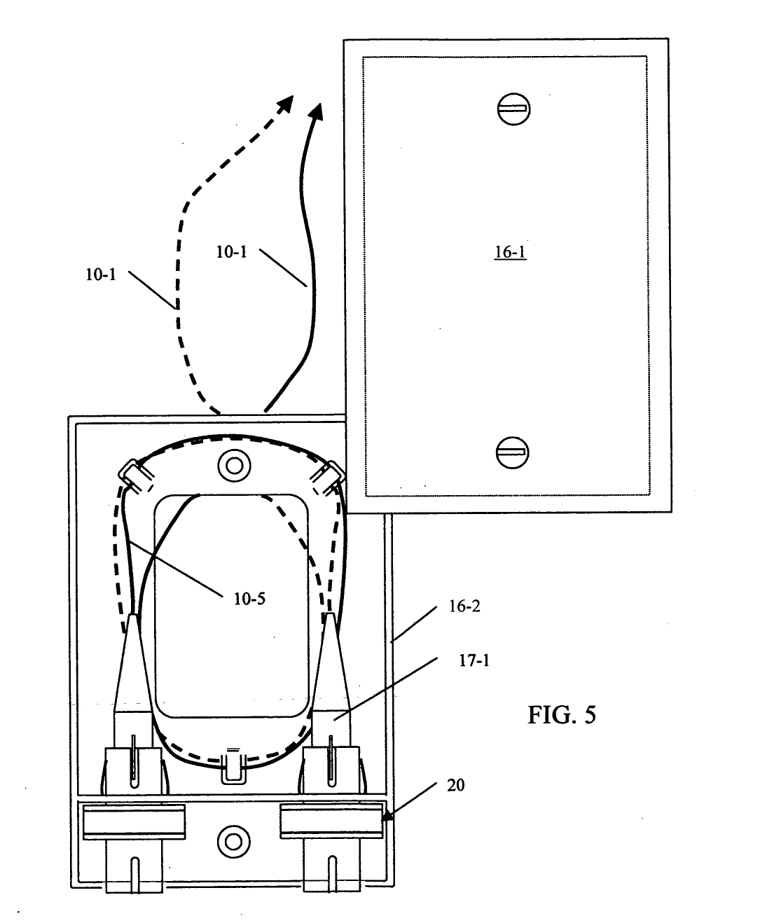

A typical application of this isolated union adapter is at locations in the network wherein the network user interconnects to the building's embedded fiber infrastructure. FIG. 5 illustrates an alternate embodiment of the union adapter integrated with a wall mount enclosure and standard electrical cover plate 16. The dimensions of such a wall mount enclosure are typically 2.4 by 4.5 inches by 0.5 inches deep. One or more adapters 20 mount within housing 15 by use of a spring clip 17 which allows for simple replacement of the expendable adapters.

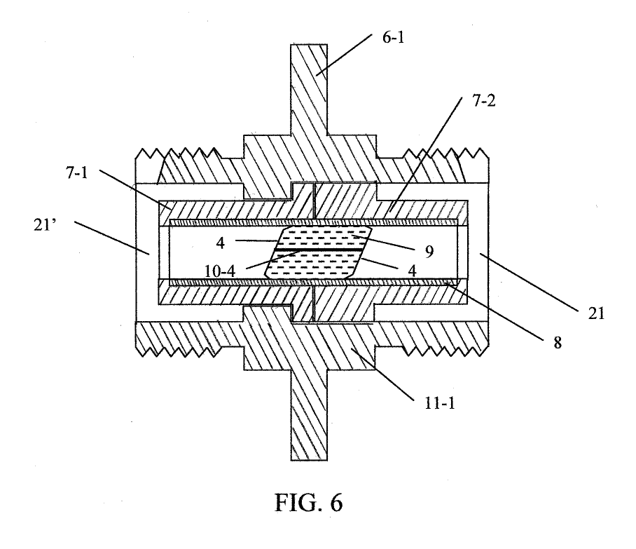

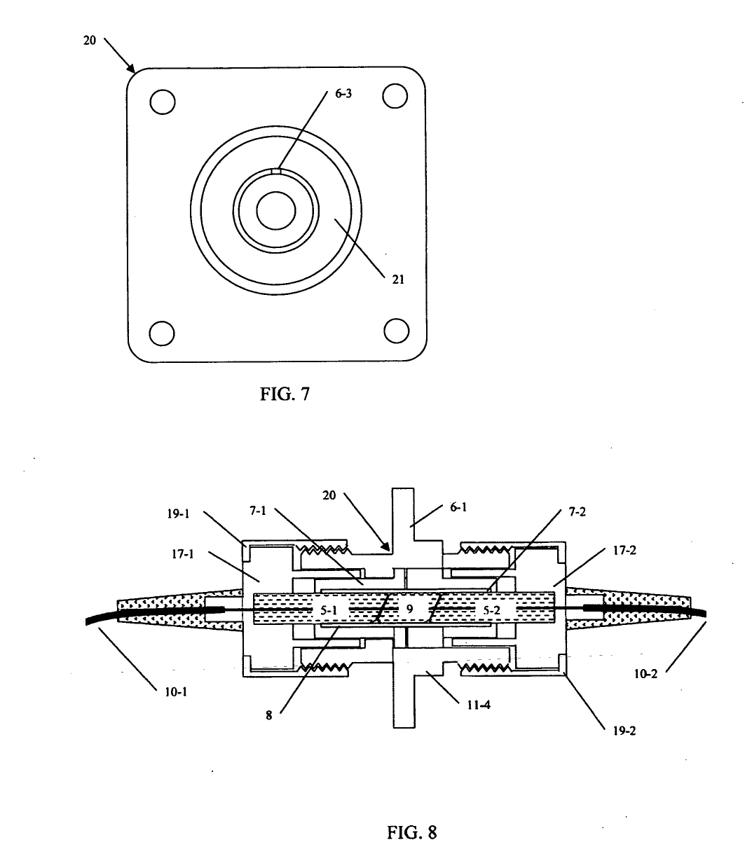

In a further embodiment of the invention, FIG. 6 illustrates a cross sectional view of an FC-APC type fiber optic union adapter for joining two male fiber optic connector ends. Note that the ST-type union adapter would be similar, but connectors attach by a push and twist attachment rather than a screw-on attachment. The housing flange 6-1 of the connector body 11-1 allows the union to be mounted to a wall plate, patch panel or panel mount 30′ by use of mounting screws, for example. Within housing 6-1 lies a precision split sleeve 8 held longitudinally and radially by a two piece outer sleeve 7-1 and 7-2. Sleeve 7-2 is fixed within body 6-1 by a friction fit, for example. Within split sleeve 8 is a fiber stub 9 including an embedded optical fiber 10-4 and having angle polished surfaces 4. As illustrated in the front view of FIG. 7, the union 20 includes a slot 6-3, which engages and aligns a mating key on the cable connector body as the connector is inserted into receptacle 21 to align the angle polished surfaces 4 relative to the angle polished ferrules of the connectorized cables inserted into the union. Fiber stub 9 can be permanently fixed by epoxy, can be held by friction fit, or can slide within the split sleeve to allow a damaged fiber stub to be removed and replaced. Alternately, multiple fiber stubs 9 within the adapter may be utilized. Should the outermost first stub be damaged during routine use, the adapter can be restored by simply removing this first stub to reveal a second internal stub.

By maintaining sub-micron concentricity of the core of fiber 10-4 with the outer diameter of fiber 10-4, and sub-micron concentricity of the ferrule 9 inner diameter and outer diameter, the excess insertion loss due to the isolated union adapter is typically less than 0.25 dB. Note that the average insertion loss for a large number of different cable pairs connected by an isolated union adapter would be about equal to twice the average insertion loss for a large number of different cable pairs connected by a standard union adapter. This is a consequence of having two optical interfaces within the adapter rather than one.

The sleeves 7-1 and 7-2 and the connector body 11-1 are typically formed by a computer numerical control (CNC) screw machine and fabricated of plated brass. The split sleeve 8 is typically fabricated of zirconia, ceramic or phosphor bronze that conforms to the 2.5 mm or 1.25 mm outer diameter of the fiber stub. The fiber stub is typically fabricated of zirconia, ceramic or fused silica, with an embedded fused silica optical fiber of 125 microns or 80 microns outer diameter. The length of the fiber stub is typically 2.5 mm to 4.5 mm long for the 2.5 mm diameter stub. The core of optical fiber 10-4 is typically 1 0 microns in diameter and propagates single spatial mode radiation at wavelengths of 1550 or 1310 nm with extremely low optical loss, or core diameter is typically 50, 62.5 microns for propagation of multi-mode radiation in the range of 800 nm to 1600 nm.

FIG. 8 illustrates a cross sectional view of the FC-APC fiber optic union adapter 20 including connectorized fiber 10-1 inserted into receptacle 21′ and connectorized fiber 10-2 inserted into receptacle 21. Fiber 10-1 is terminated at ferrule 5-1 within connector body 17-1 with a screw on cap 19-1 that maintains the connector attached to union housing 11-4. Fiber 10-2 is terminated at ferrule 5-2 within connector body 17-2 with a screw-on cap 19-2 that attaches the connector to union housing 11-4. The flange of connector body 6-1 allows the union to be mounted to a wall plate or panel mount, for example. Inside body 6-1 is the precision split sleeve 8 within two-piece sleeve 7-1 and 7-2. Sleeve 7-2 is fixed within body 11 -1 by a friction fit, for example. The fiber stub is epoxied within split sleeve 8. The ends of fiber stub 9 are prepared with angle polished faces 4 in this example, but flat polished faces 4′ are also used in those applications less sensitive to backreflections. End faces 4, 4′ may optionally be antireflection coated to minimize wavelength dependent transmission and phase ripple due to multi-path interference or etalon effects. Standard multilayer dielectric antireflection coatings can reduce the reflection strength to <−25 dB.

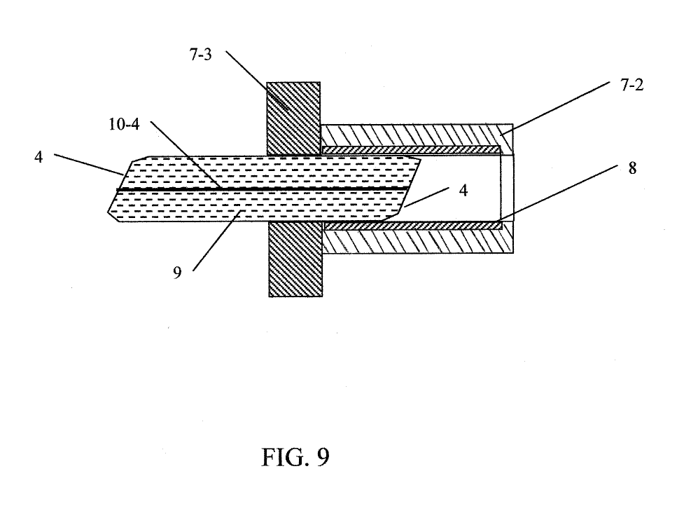

In an alternate embodiment, a union adapter can be provided to interconnect a male-to-female fiber optic termination. FIG. 9 illustrates a cross sectional view of the fiber stub-ferrule subassembly for a fiber optic male-to-female adapter. The housing is not shown. This configuration enables the adapter to be inserted between the male end of a fiberoptic cable and a female termination incorporated in the housing of an optical transceiver, for example. The adapter introduces low excess loss by utilizing low optical attenuation single mode or multi-mode fiber within the isolating fiber stub. In this particular example, the adapter includes a split sleeve 8 within holder 7-2. The mounting sleeve 7-3 is attached to fiber stub 9. Fiber stub 9 has polished end faces 4 and embedded optical fiber 10-4, one end of which is internal to split sleeve 8. End faces 4 may optionally be antireflection coated to minimize any transmission ripple. Optical fiber 10-4 may exhibit single mode or multi-mode propagation characteristics. The housing body may be of the FC, ST, SC, LC, MTRJ or other industry standard connector styles, in a simplex or duplex configuration. The polished end faces 4 can be the APC, PC, UPC or other industry standard types.

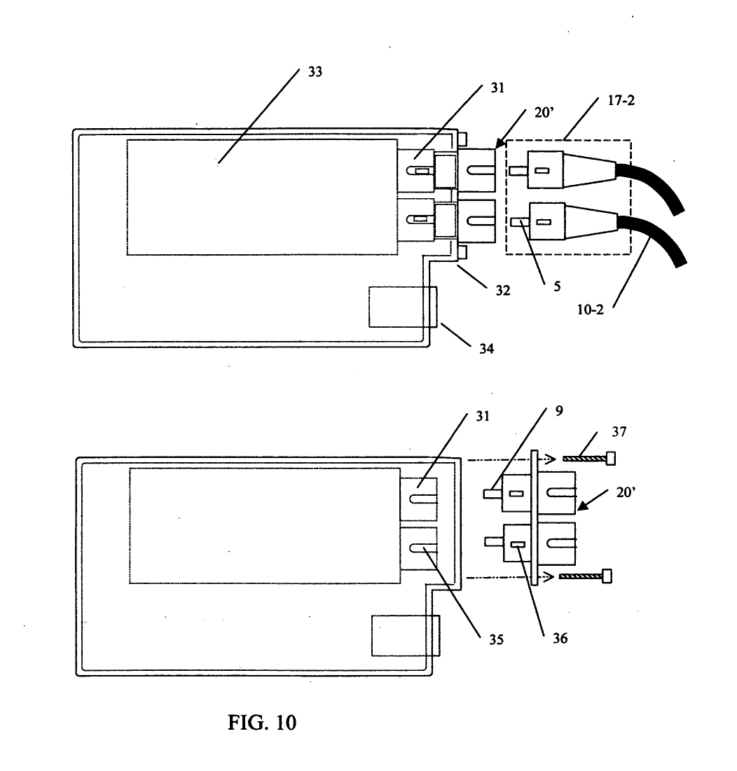

In a particular example, the male-to-female isolating adapters are used to isolate the fiber optic ports of a fiber optic transceiver module, an example of which is illustrated in FIG. 10. This module may be a fiber optic Ethernet transceiver transmitting at rates up to 10 Gbit/sec and including electrical signal conversion/communication via connector 34. The transceiver module 33 is packaged within a housing 32 and includes integrated duplex, female-type fiber optic receptacles 31. These receptacles 31 are of the SC-UPC type with either multi-mode or single mode fiber interfaces, for example, and with alignment channels 35. Damage to the internal fiber interfaces within receptacle 31 is not readily repaired. To protect this interface from damage, we disclose herein a transceiver unit with integrated isolating adapter 20′ which insert into a mating cavity within transceiver housing 32. The adapter 20′ prevents the ferrules 5 of external terminated fiber optic cables 17-2 from contacting the receptacles 31 in the transceiver unit 33. In this way, should a cable 10-2 with damaged or contaminated ferrule 5 be inserted into 20′, damage is restricted to the inexpensive, replaceable adapter 20′ rather than the transceiver 33. The adapter is attached to the housing by semi-permanent means, such as screws 34 which hold adapter 20′ to enclosure 32. This attachment prevents the user from exposing the receptacles 31 during routine use. Repair of transceiver 33 requires a simple replacement of adapter 20′. The internal structure of adapter 20′ including a fiber stub 9 and alignment sleeve 8 is illustrated in FIG. 9.

In certain fiber optic network deployments, it may be advantageous to utilize bend insensitive fiber within the customer's premises so that fiber optic patchcords incorporating this fiber are more robust under bending and routine handling. In many cases, the fiber drop cable 10-1 entering the customer's premises is standard single mode optical fiber. Directly interfacing connectorized single mode fiber and connectorized, bend insensitive fiber can result in relatively high insertion loss (>0.5 dB) and signal degradation. In an additional embodiment of this invention, low loss interconnection between dissimilar fiber types is provided by utilizing a fiber stub element within a union adapter including an adiabatically tapered waveguide transition. A low optical loss transition between fibers with dissimilar core diameters, as is the case for standard and bend insensitive fiber, can be achieved by utilizing an adiabatic taper of the core diameter to smoothly and continuously transition from one fiber diameter to the other within a longitudinal distance greater than the beat note length determined from the difference in propagation constants between the two fibers. This distance is typically between 10 and 1000 microns, depending on the fiber core diameters and wavelength of operation. This range of lengths enables the fiber to be packaged within the stub in a compact fashion. The stub length is typically 4 mm.

The adiabatic taper within the isolating fiber stub may be fabricated by partially diffusing out the core at one end of a bend insensitive fiber to match the mode field diameter of a particular single mode fiber and fusion splicing this end to the particular single mode fiber. The adiabatic taper is formed longitudinally adjacent to the fusion splice and is part of a continuous length of fiber which can be epoxied into a ferrule to produce a fiber stub with different core diameters at the opposite end faces. This fiber stub is fixed at the center of the union adapter. In this case, a standard single mode fiber cable termination can be attached to a bend insensitive, single mode fiber cable with low insertion loss (<0.10 dB).

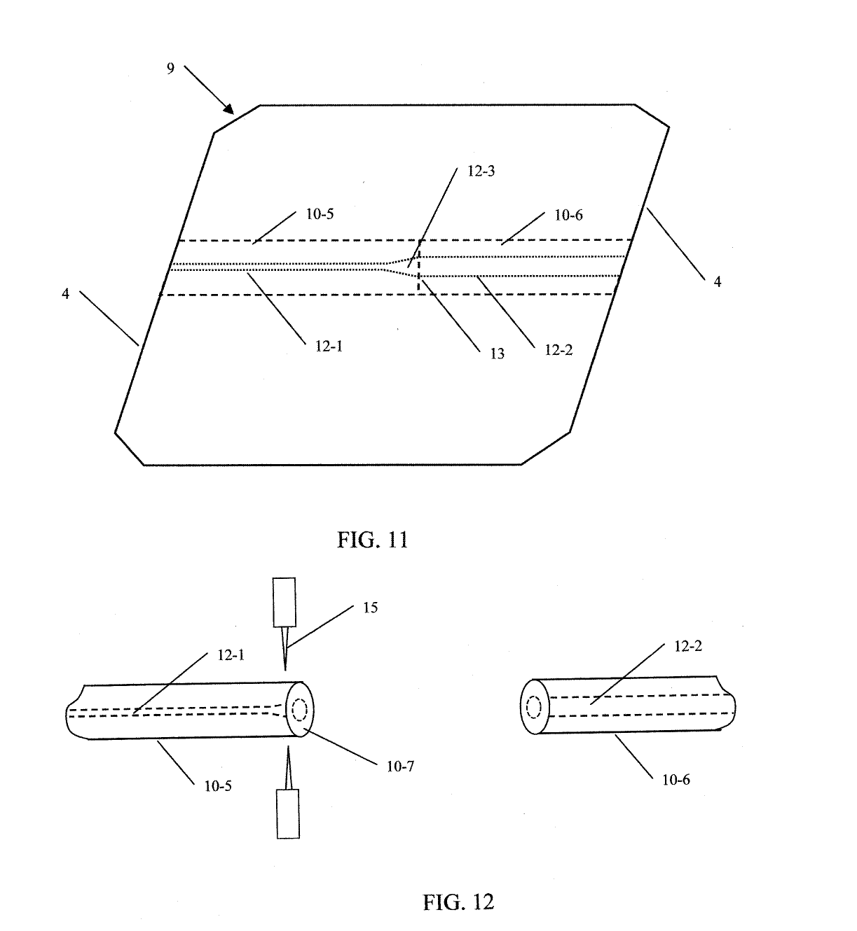

FIG. 11 details the fiber stub including fusion-spliced optical fibers with an adiabatic taper. Bend insensitive fiber 10-5 has a core 12-1 of generally smaller diameter than standard single mode fiber 10-6 with core 12-2. The diameter of core 12-1 is typically 6 to 8 microns and the diameter of core 12-2 is typically 9-10 microns.

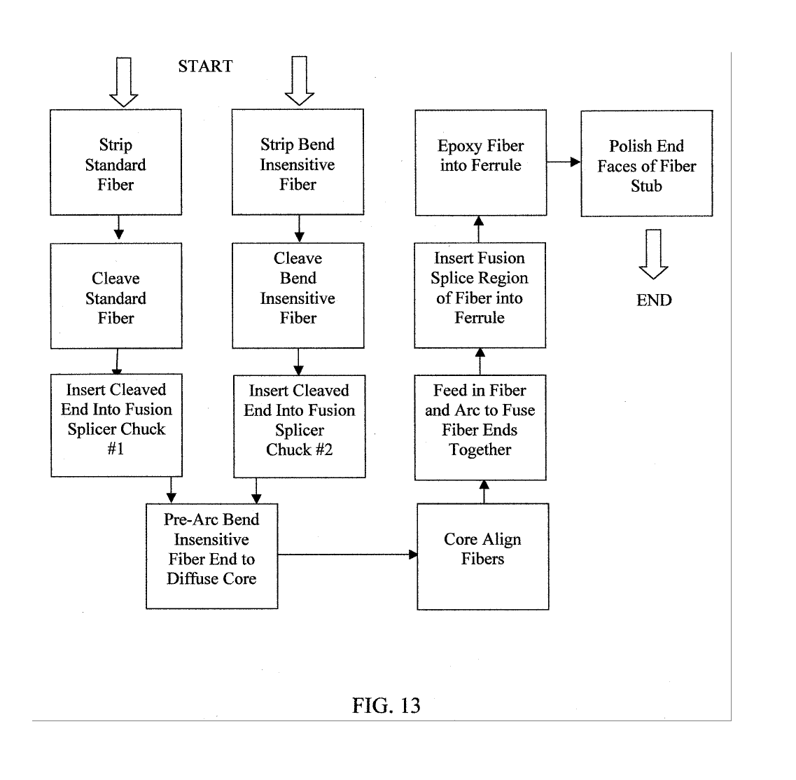

In a particular example (FIG. 12), the adiabatic waveguide taper within the bend insensitive fiber is formed by using a fusion splicer's electrical pre-arcing (heating before fusion splicing) or post-arcing (heating after fusion splicing) process, for example, to heat the end of the bend insensitive fiber and diffuse out the core to enlarge the mode field diameter locally. Pre- or post-arcing functionality is available on standard fusion splicers such as the Alcoa-Fujikura Model 50FS. Alternate approaches to diffusing the core include localized heating with a CO₂ laser emitting at a wavelength of 10.6 microns or with mini-torches such as the hydrogen gas-type used to fabricate fused couplers. Fiber cleaving can be provided by use of standard precision cleavers manufactured by Alcoa-Fujikura or Sumitomo. The two fibers are contacted and heated to form a fusion splice with interface 13 and adiabatic taper 12-3. The fibers 10-5 and 10-6 are subsequently inserted and bonded into the fiber ferrule to form a fiber stub 9 assembly. The end faces 4 of the fiber stub 9 are polished to mate with standard angle polished or flat polished connectors. FIG. 13 illustrates the flow chart outlining the process steps to produce a fiber stub including an adiabatic transition.

Fiber optic networking equipment such as transceivers, modems and patch panels typically include large numbers of fiber optic unions or adapters to mate connectorized fiber optic cables. These unions join fibers in locations where permanent fusion splices are inappropriate because of the need to periodically reconfigure or replace fiber optic cables. A great limitation in prior art devices is the fact that if one cable's ferrule is dirty or damaged, it will likely transfer damage to the mating ferrule because the union physically contacts the polished enfaces of both ferrules to one another. In many cases, the damaged mating ferrule is part of a critical cable deeply embedded within the fiber optic plant. Replacing such a critical cable is a costly process. To eliminate this damage, we have disclosed the use of an inexpensive component consisting of an isolating fiber stub embedded within the adapter. In this fashion, the damaged ferrule would not damage the mating ferrule of the critical cable. The disposable fiber optic adapter isolates critical fiber optic terminations from damage.

Those skilled in the art will readily observe that numerous modifications and alterations of the device may be made while retaining the teachings of the invention. Accordingly, the above disclosure should be construed as limited only by the metes and bounds of the appended claims.

1. An adapter unit providing low optical loss interconnection between terminal connectors at the ends of fiber optic lines and isolating one terminal connector from damage to facilitate the restoration of transmission across an affected optical link, the terminal connectors including end ferrules of predetermined diameters and having polished end faces with included optical fiber waveguides along the central axis thereof and adjacent means for engaging a retainer body for the unit, the adapter comprising:
an alignment sleeve substantially concentric about a central longitudinal interconnection axis, the alignment sleeve having an inner diameter sized to receive the end ferrules, and a length for receiving both ferrules and an intermediate element and being of a yieldable material and having a longitudinal gap and a compliance such that it provides high accuracy in positioning the ferrules and intermediate element diametrically with respect to the central axis when inserted;
at least one interconnection stub diametrically sized to fit within the sleeve and being positioned diametrically with high accuracy by the sleeve, the at least one stub having polished end faces angled to abut the end faces of adjacent ferrules on inserted terminal connectors, the stub including a central optical fiber waveguide corresponding to the central optical waveguides in the ferrules, and
a retainer body encompassing the sleeve and coupled thereto, said body including elements for securement to the means of the terminal connectors for engaging the retainer body.

2. An adapter unit as set forth in claim 1 above, wherein the diameter of the interconnection stub is in the range of about 1.25 mm to 2.50 mm to match the diameter of the ferrules, wherein the end faces on the stub are angled to match the angles of the end faces of the ferrules and the stub includes a centrally embedded optical fiber waveguide having a diameter of the order of 125 microns which is principally of the class of transparent materials including fused silica.

3. An adapter unit as set forth in claim 2 above, wherein the embedded optical fiber waveguide in the interconnection stub is identical in optical characteristics to the adjacent fiber optic waveguides in the ferrules and the end faces are centrally convexly domed for contact of the end faces in the region of the fiber optic waveguides.

4. An adapter unit as set forth in claim 2 above, wherein the retainer body is injection molded plastic and/or metal and the alignment sleeve is from the class of materials including zirconia ceramic and phosphor bronze.

5. An adapter unit as set forth in claim 1 above, wherein the unit includes at least two stubs disposed in series within the sleeve between the end ferrules and removable therefrom to permit replacement in the event of damage to an end face.

6. An adapter unit as set forth in claim 2 above, wherein the alignment sleeve is fabricated from the class of materials comprising zirconia and phosphor bronze, wherein the fiber stub has a length from about 1 to about 3 times the stub diameter and the stub body is fabricated from the class of materials comprising zirconia and fused silica and further including a holder in the retainer body receiving and retaining the alignment sleeve, the holder being divided transversely along the sleeve length.

7. An adapter unit as set forth in claim 1 above, wherein the adapter unit is for connecting two male optical fiber connector ends, and the retainer body includes engagement means for locking the two male optical fiber connector ends.

8. An adapter unit as set forth in claim 1 above, wherein the adapter device is for interconnecting male and female terminal connectors, and wherein the retainer body includes a sleeve extending from a first end thereof and the retainer body includes an engagement mechanism radially spaced from the sleeve, and wherein the second end of the retainer body includes a portion of the stub extending from the sleeve, and the retainer body includes an engagement mechanism for receiving the male portion of a second optical fiber connector.

9. An adapter unit as set forth in claim 8, further comprising a complementary connector retainer in a fiber optic transceiver including a cavity to which the retainer body mates, and wherein the stub extending from the sleeve of the adapter unit inserts into the complementary connector retainer cavity of the fiber optic transceiver, the adapter thereby isolating the optical connection within the mating receptacle cavity of the transceiver from direct and repeated physical contact with the fiber optic connector attached thereto.

10. An adapter unit for enabling isolated physical coupling and low loss optical coupling to complete a communication link between end faces of opposing ferrule tipped terminals including central optical fiber cores, comprising:
a housing body encompassing a longitudinal central optical communication axis;
a sleeve holder having a central aperture about the central axis and mounted as to be movable in the housing body:
a sleeve disposed within the aperture in the sleeve holder and extending therethrough, the sleeve being concentric with the longitudinal optical fiber axis and defining opposite end receptacles sized for receiving the ferrule terminals of optical fiber connectors, and
at least one fiber optic stub disposed within the sleeve between the opposite end receptacles, the at least one stub including polished end faces with convex curvatures on the opposite ends thereof for engagement with the opposed end faces of ferrules inserted and retained in the sleeve, the stub including a central fiber waveguide core in alignment with the optical fiber axis and an encompassing material, the end faces of the stub being configured to closely abut the opposing end faces of ferrule tipped terminals and providing substantial optical continuity along the central fiber waveguide cores.

11. An adapter unit as set forth in claim 10 above, the sleeve holder divided transversely relative to the central axis, wherein the sleeve is a semi-rigid cylindrical element spanning between the end receptacles, and having a longitudinal separation and an inner diameter sized relative to the stub to maintain the central fiber cores of the stub and the ferrules in alignment to high accuracy relative to the longitudinal optical fiber axis.

12. An adapter unit as set forth in claim 11 above, wherein the unit includes more than one stub removably positioned in the sleeve, between the end receptacles, and in end to end contact, whereby a stub can be removed if an end face is damaged, and the end face of an adjacent ferrule terminal is engaged against the extra stub.

13. (canceled)

14. An adapter unit as set forth in claim 10 above, wherein the stub has a diameter of from about 1.25 mm to about 2.50 mm and a length from about 1 to about 5 mm.

15. An adapter unit as set forth in claim 10 above, wherein the stub includes a substantially central longitudinal optical fiber having two different core diameters at the end faces and coupled together at a central location by a continuous transition of the cross sectional diameter of the core.

16. A disposable fiber optic union adapter for providing a low optical loss changeable interconnection between first and second optical fibers mounted in first and second ferrules having polished end faces at a predetermined angle to a plane transverse to the optical axis thereof and the adapter further providing replacement capability such that physical damage to the polished end face of one optical fiber need not be transferred to the polished end face of the other optical fiber, comprising:
an adapter body including a length of cylindrical fiber optic ferrule extending therefrom in a first direction and including a first alignment channel along the ferrule longitudinal axis for aligning a second ferrule from a second direction opposite to the first,
a length of third optical fiber ferrule substantially identical to the first and second ferrules and comprising a third optical fiber including an element engaging the first alignment channel of adapter body to form a fiber stub assembly having convex end faces at angles substantially identical to the polished end faces of the first and second ferrules and providing therewith in combination a low insertion loss,
a sleeve within the adapter body the sleeve having a second interior channel with inner diameter sized in diameter and length to accept the fiber stub assembly and the first and second ferrules,
the fiber stub assembly being positioned at a longitudinally central location within the sleeve second interior channel,
the fiber stub assembly isolating the first and second polished end faces of the optical fibers from direct physical contact with one another and being separable from the first and second optical fibers to permit optical continuity when a different ferrule is inserted into the sleeve.

17. An adapter in accordance with claim 16 wherein the first and second optical fibers are single mode fibers with nominal core diameters of 10 microns and cladding diameter of 125 microns, with the diameter of the first inner channel being in the range of 125 to 127 microns and the nominal diameter of the second interior channel being in the range of 2.5 mm to 1.25 mm.

18. An adapter in accordance with claim 16 wherein the first and second optical fibers are single mode with different nominal core diameters and the length of third optical fiber includes a dissimilar fiber fusion splice which gradually tapers at a longitudinally central location between the different nominal core diameters.

19. (canceled)

20. (canceled)

21. (canceled)
